(19) United States
(12) Patent Application Publication
(10) Pub. No.: US 2016/0151725 A1
(43) Pub. Date: Jun. 2, 2016

(54) Re-usable Water Filter with Two Flushing Connectors

(71) Applicant: Village Water Filters, Inc., Silverthorne, CO (US)

(72) Inventor: Robert Ashley, Silverthorne, CO (US)

(21) Appl. No.: 14/957,242

(22) Filed: Dec. 2, 2015

Related U.S. Application Data
(60) Provisional application No. 62/086,377, filed on Dec. 2, 2014.

(51) Int. Cl. B01D 29/66; B01D 35/30; C02F 1/00

(52) U.S. Cl. CPC B01D 29/66; C02F 1/003; B01D 35/306; C02F 2303/16

(57) ABSTRACT

A water filter in a housing is provided. The housing has an input opening and an output opening to allow the water to be filtered to flow through filter. The output opening has at least one fitting to allow a standard water bottle with a threaded cap closure to attach to the output opening to back flush the filter.

### CROSS REFERENCE APPLICATIONS

This application claims the benefit of U.S. provisional application Ser. No. 62/086,377 filed Dec. 2, 2014, which is hereby incorporated by reference in its entirety for all purposes.

### BACKGROUND

The necessity for clean water is a basic human need. It is estimated that in 2014 more than 3.4 million people a year die from sanitation related causes. Approximately 780 million people lack access to an improved water source, which is about one in nine people in the world. In 2013 is was estimated that almost two in three people lacking access to clean water survive on less than $2 a day, with one in three living on less than $1 a day. Further, more than 660 million people without sanitation live on less than $2 a day, and more than 385 million on less than $1 a day. Therefore, the people most in need of clean water cannot afford even a nominal cost to obtain and/or maintain a water filtering system. Although there are known reusable water filters that can be set up for use in remote areas, all of the known ones has issues with maintenance. For example, Sawyer International makes a water filter kit designed for use with a standard five gallon bucket that can filter up to 170 gallons of water per day. Information on this filter can be found at:http://sawyer.com/products/sawyer-point-zerotwo-bucket-purifier-assembly-kit/

The system is capable of filtering enough water that a single filter could be used in a small village. Thus increasing the likelihood of the village being able to afford it or for a charity or other non-governmental organization to be able to fund giving the kits to villages. However, over time, the filter becomes clogged with particulates and needs to be back flushed in order to restore its function. The current design of the system is to provide a large syringe that attaches to the output side of the filter. This syringe is to be filled with (clean) water and used to flush water back through the filter to remove the particulates clogging the filter. The large syringe is capable of providing the needed pressure to allow the filter to be cleaned. However, the syringe can get lost, broken or used for other purposes. In remote areas, it can often be impossible to find a replacement syringe, even if the money exists to buy a new one, which it often does not. Once this happens, the filter becomes useless.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the present disclosure is to provide a re-usable water filter that allows for more than one type of container to be attached to it such that the filter can be back flushed.

Another aspect of the present disclosure is to provide a re-usable water filter that can be back flushed with a common household item that is widely available worldwide.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

A water filter in a housing is provided. The housing has an input opening and an output opening to allow the water to be filtered to flow through filter. The output opening has at least one fitting to allow a standard water bottle with a threaded cap closure to attach to the output opening to back flush the filter.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a side plan view of the filter housing.

FIG. 2 is a bottom side isometric view of the filter housing.

FIG. 3 is an exploded view of the filter and the filter housing.

FIG. 4 is a exploded view of the filter housing and the components to attach the filter to a bucket or similar container.

FIG. 5 is a side perspective view of the filter mounted on a bucket.

FIG. 6 (prior art) is a side perspective view of the syringe flushing device.

FIG. 7 is a side perspective view of a bottle attached to the filter to act as a flushing device.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

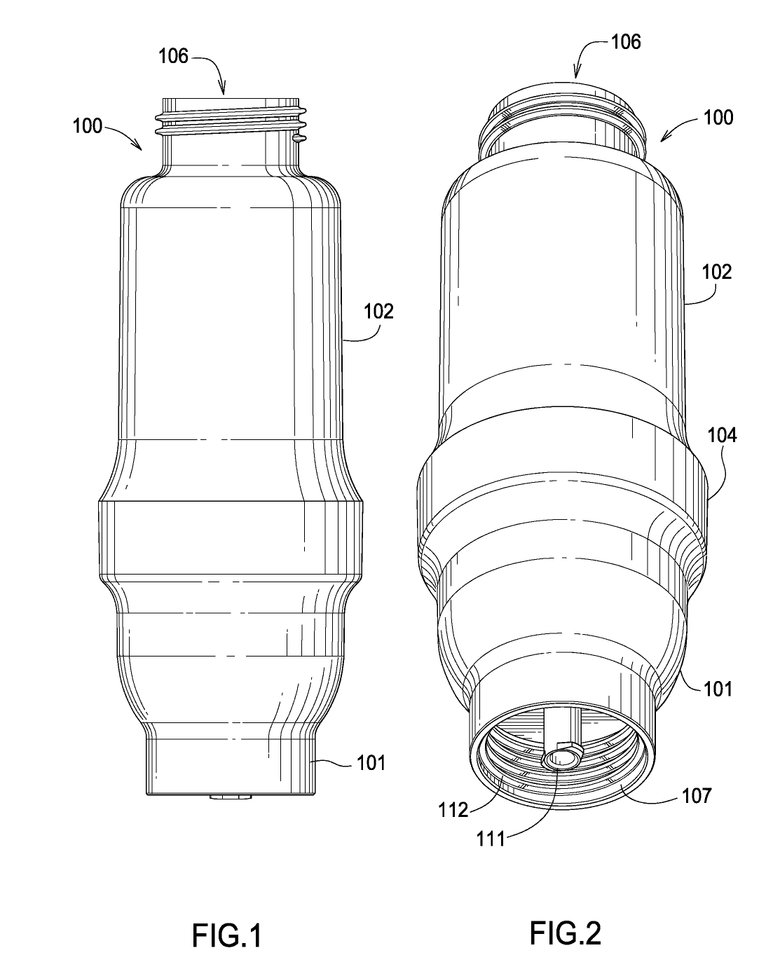

Referring first to FIGS. 1 to 3, a reusable water filter 100 has a two part housing 101 and 102 with a filter cartridge 103 inside. The upper section 101 threads to the bottom section 102 at join 104. The water filter in the depicted embodiment is made from 0.1 micron hollow ploysulfone membrane. Depending on the desired level of filtering, other filters can be used. If filtering water with a high level of particulates, a pre-filter can be used as well.

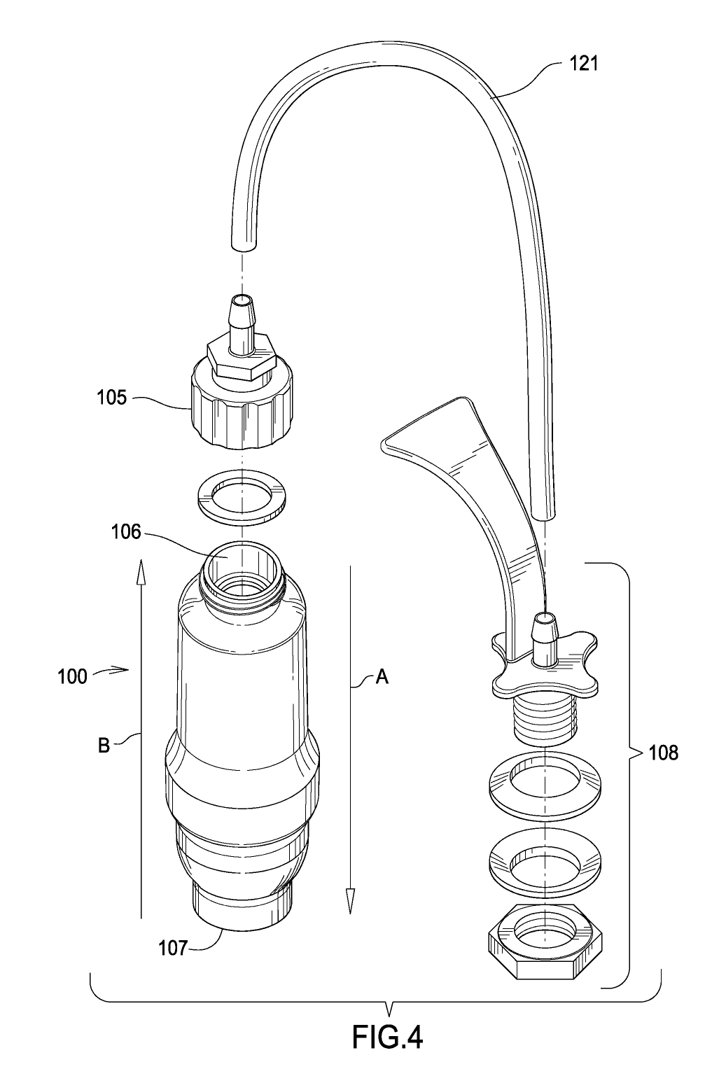

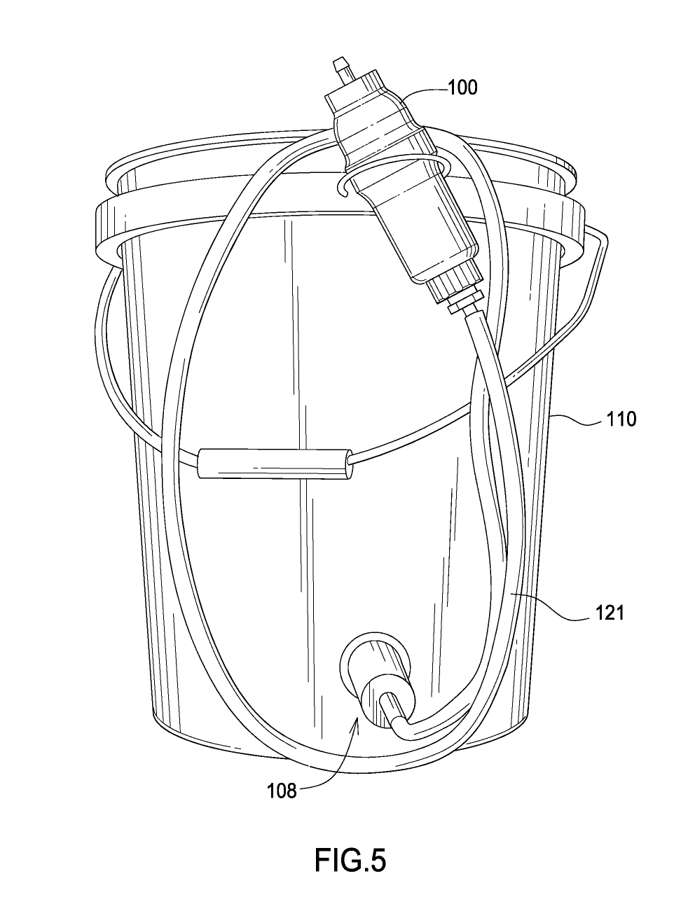

The filter 100 is attached to a feed hose 121 with adapter 105, as depicted in FIG. 4. The adaptor 105 threads on the upper section 101 of the housing at input opening 106 to allow the water to be filtered to flow through the hose and to the filter, to exit from the housing at output opening 107 in the direction shown by arrow A. Filtered water exits from output opening 107 to a desired container. If desired, a spigot adaptor 108 can be provided to allow the hose 121 to be easily connected to any existing container, such as a bucket 110 as depicted in FIG. 5. Two different styles of spigot adaptor 108 are shown in FIGS. 4 and 5. Any number of different spigot adaptors can be used, no limitation is intended or should be inferred. This allows a user to create an easy to use water filtration system.

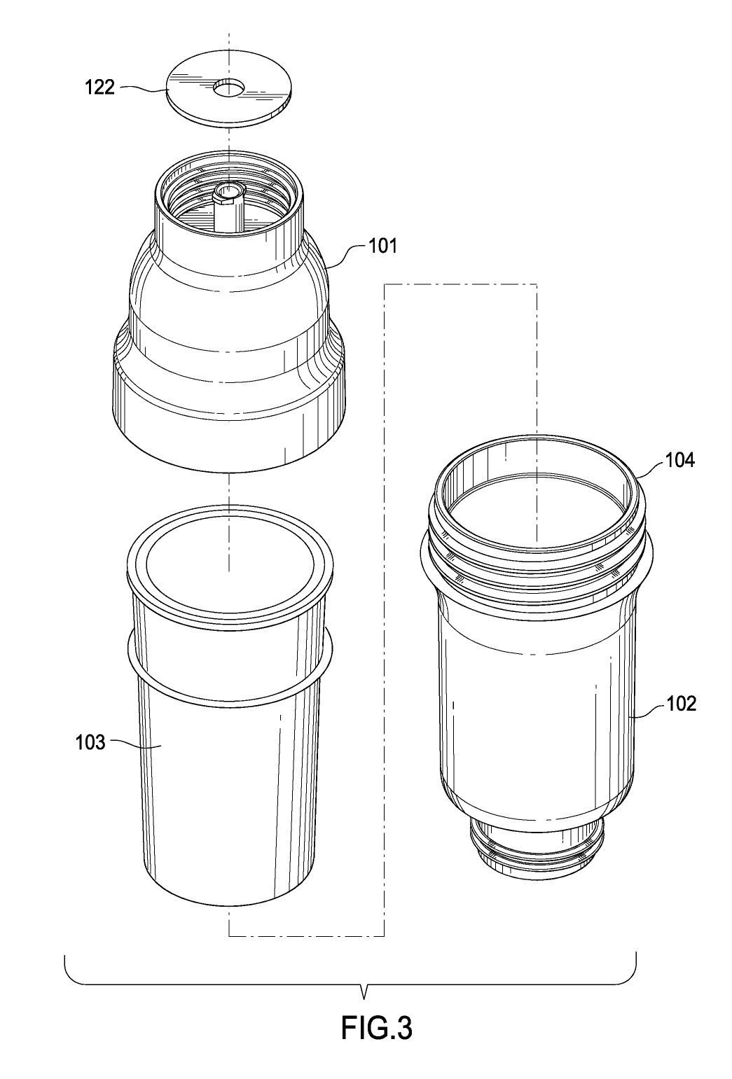

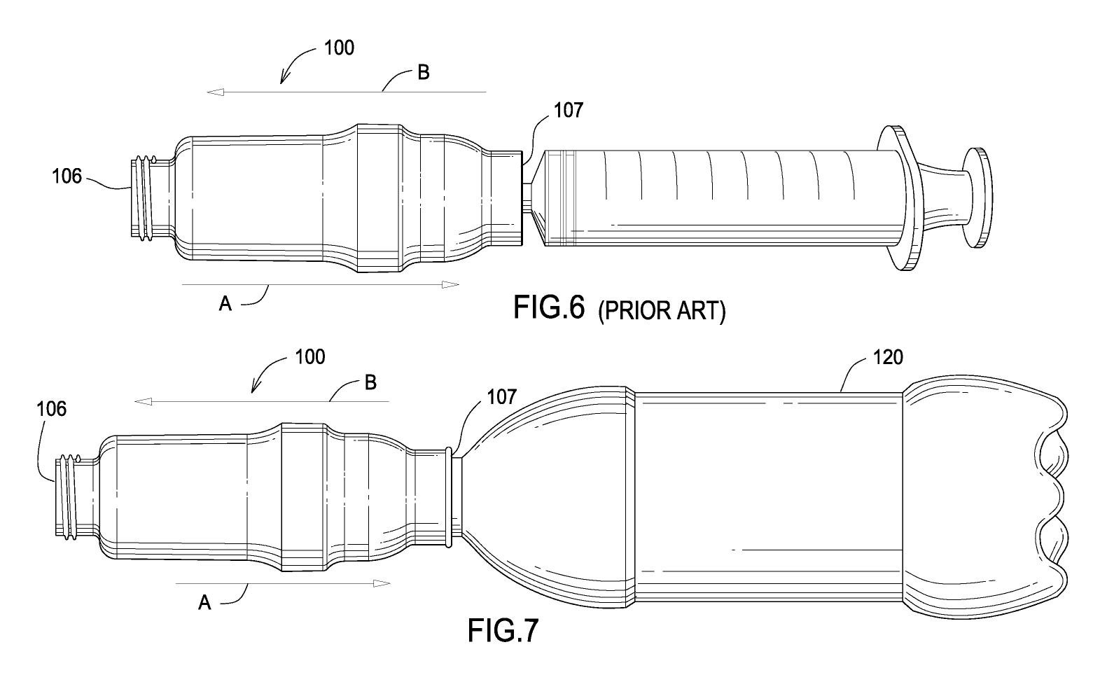

Eventually, the filter will become clogged with particulates, reducing the flow rate to a point where it is no longer practical to use the filter. Also, if a user knowingly puts water in the bucket with a very high particulate load, the filter could become completely clogged regardless of the amount of prior use. Therefore, it is important that water filters of this type have a back flush mechanism to allow a user to maintain the filter in working conditions for as long as possible. If the filter is able to filter out pathogens that include viruses, the filter pore size will be quite small. All of these things mean that some water pressure in needed to back flush the filter by following water from output opening 107 to input opening 106 in the direction show by arrow B. Merely trying to back flow water through opening 107 generally cannot be done with enough pressure to force the particulates out of the filter. As discussed above, the prior art filter has an attachment 111 for a syringe. The attachment 111 is shown in FIG. 2; the syringe attached to the filter is shown in FIG. 6. The plunger with its rubber stopper and small exit opening allow a user to generate enough pressure to flush the filter when attached to the narrow diameter of attachment 111. Referring to FIGS. 3 and 7, the present device has a set of attachment threads 112 inside output opening 107 to allow a flexible water bottle 120 to be attached to the output end of the filter housing. Flexible washer 122 is placed around the attachment 111 and extends to an interior wall that has the threads 112 to provide a good seal of the plastic water bottle and to ensure that the water being pushed out of the plastic water bottle 120 is accelerated by being forced through the small diameter of attachment 111. Plastic water bottles 120 are ubiquitous worldwide. Even the poorest people on the planet generally have access to plastic water bottles, even if just from the rubbish of others better off than they are. The output opening 107 and the threads 112 are sized and configured to be able to attach to the majority of water bottles that are closed with a threaded cap.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. In general the terms and phrases used herein have their art-recognized meaning, which can be found by reference to standard texts, journal references and contexts known to those skilled in the art. The above definitions are provided to clarify their specific use in the context of the invention.

I claim:

1. A portable, reusable water filter comprising:
a housing having a first and second section, the first and second sections enclosing a water filter;
the first section having an input opening and the second section having an output opening to allow water to be filtered to flow longitudinally through the water filter from the input opening to the output opening in a filtering direction of the water filter;
a first flushing fitting on the second section that is encircled by the output opening, the first flushing fiting having a smaller diameter opening that the first to allow a flushing flow of fluid to be accelerated into the filter to back flush the water filter, the first flushing fitting being adapted to allow a syringe to be connected to back flush the water filter.
the input opening having an input fitting to allow it to be removably connected to a supply of water to be filtered; and
the output opening having a second flushing fitting to allow a standard, flexible drinking water bottle with a threaded cap closure to attach to the output opening to back flush the water filter.

2. The portable, reusable water filter of claim 1, wherein the first flushing fitting has a threaded section to removably attach to a standard drinking water bottle.
